(19) United States
(12) Patent Application Publication
(10) Pub. No.: US 2014/0158608 A1
(43) Pub. Date: Jun. 12, 2014

(54) FILTER ASSEMBLY FOR FLUID SYSTEM

(71) Applicants: Jason R. Pranger, Tinley Park, IL (US); Richard D. Gjerde, Braceville, IL (US)

(72) Inventors: Jason R. Pranger, Tinley Park, IL (US); Richard D. Gjerde, Braceville, IL (US)

(73) Assignee: ILLINOIS TOOL WORKS INC., Glenview, IL (US)

(21) Appl. No.: 14/234,062

(22) PCT Filed: Jul. 20, 2012
(86) PCT No.: PCT/US2012/047623

§ 371 Date: Jan. 21, 2014

Related U.S. Application Data
(60) Provisional application No. 61/510,580, filed on Jul. 22, 2011.

(51) Int. Cl. B01D 29/01

(52) U.S. Cl. CPC B01D 29/01; B01D 29/012
USPC 210/446; 264/279

(57) ABSTRACT

A filter assembly having a hollow body defining a flow passage between its ends, a porous filter media disposed obliquely across the flow passage between the ends. In one form the filter media is a stainless steel mesh screen overmolded into the body.

### CROSS-REFERENCE TO RELATED APPLICATION

This application claims the benefit pursuant to Title 35 USC §119(e) to Provisional Application No. 61/510,580, filed Jul. 22, 2011, the entire content of which is hereby incorporated by reference as if fully set forth herein.

### BACKGROUND OF THE INVENTION

This disclosure relates to tubular filtration apparatus for fluid systems. More particularly, it relates to such apparatus having the length of a coupling element with a filter element in the fluid flow path.

Gas or liquid fluid systems commonly include a filtration apparatus to separate contaminants from the flowing medium. In some applications, the device takes the form of a fluid coupling interposed between adjacent sections of tubular conduit connected to it in fluid tight relation. The coupling includes a filter element to filter the fluid flowing within the system.

Systems involving such filtration apparatus include automotive fuel and vapor lines, automotive air conditioning systems including refrigerant flow paths, power steering systems and most recently, temperature control systems for hybrid battery installations. They are also extant in many other disciplines including medical treatment, commercial or residential refrigeration systems, as well as other fluid systems.

Known arrangements of filter couplings include a housing with a generally cylindrical filter element extending beyond one end of the coupling. Such arrangements present certain design and system challenges. For one, the coupling itself is of significant length due to the extended frame supporting the filter media. This length requirement must be accommodated in the associated system design. It also adds to cost of system assembly. Moreover, since the filter element extends from one end of coupling it must be properly oriented in regard to fluid flow further complicating the assembly process and adding to assembly time and cost. It also dictates a radial fluid flow through the filter media, thereby impacting fluid flow considerations. With such apparatus, particulate matter tends to collect on the filter media which eventually clogs leading to potential system failure. Also, the skeletal framework actually impedes flow and creates a significant pressure drop within the fluid system. These factors dictate an overall increase in the length of the filter element to provide adequate capacity.

### SUMMARY OF THE DISCLOSURE

The filter assembly of the present disclosure eliminates the negative attributes of currently utilized devices. It comprises a body defining a flow passage between its ends, with a porous filter media disposed obliquely across the flow passage. It is symmetrical between its ends. In one form it comprises a hollow tubular body defining a flow passage with the filter media overmolded into the hollow tubular body.

### DESCRIPTION OF THE DRAWINGS

FIG. 1 is a perspective view of a known filter coupling;

FIG. 2 is a cross-sectional plan view of the known filter coupling of FIG. 1;

FIG. 3 is a perspective view of a filter coupling of the present disclosure;

FIG. 4 is a plan view of the filter media of the filter coupling of FIG. 3;

FIG. 5 is a sectional perspective view of the filter coupling of FIG. 3;

FIG. 6 is a sectional view of a filter housing in a fluid flow path illustrating the principles of the filter of the present disclosure.

FIG. 7 is an end view of a filter coupling in accordance with the principles of the present disclosure showing a slightly modified form;

FIG. 8 is a sectional plan view of the filter coupling of FIG. 7 taken along the line 8-8 of FIG. 7.

### DETAILED DESCRIPTION OF THE ILLUSTRATED EMBODIMENTS

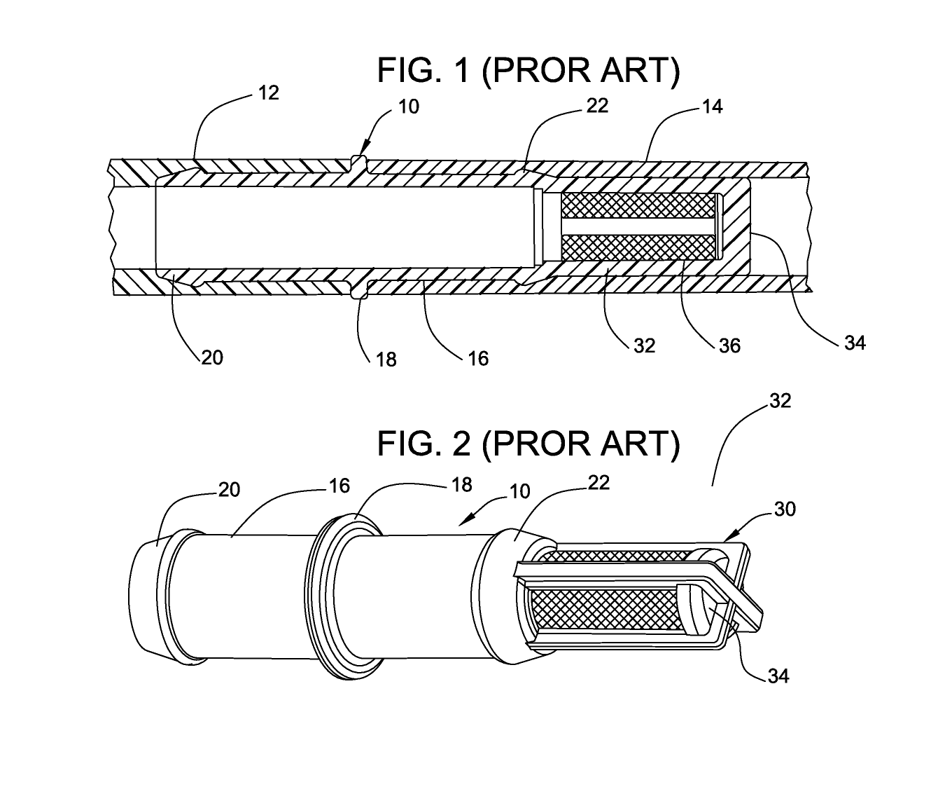

An example of a currently available coupling filter apparatus for a fluid line is found in FIGS. 1 and 2. Here, a coupling filter generally designated 10 is disposed in a fluid system represented by tubular flow conduits in the form of hoses 12 and 14. The coupling filter 10 includes a hollow tubular body 16 with a central radial stop 18 to limit insertion into a associated conduit. Body 16 of the cylindrical body further includes radial outward annular barbs 20 and 22 at its ends. The body receives the flexible hoses 12 and 14 in fluid tight relation. The connected hoses and hollow body 16 of filter coupling 10 represent a continuous fluid flow path.

A filter element 30 is positioned at one end of filter coupling 10. It is an elongate skeletal frame 32 with a closed end 34 supporting a generally cylindrical open mesh filter screen 36. Fluid flowing within the system passes radially through the screen which captures particulate impurities.

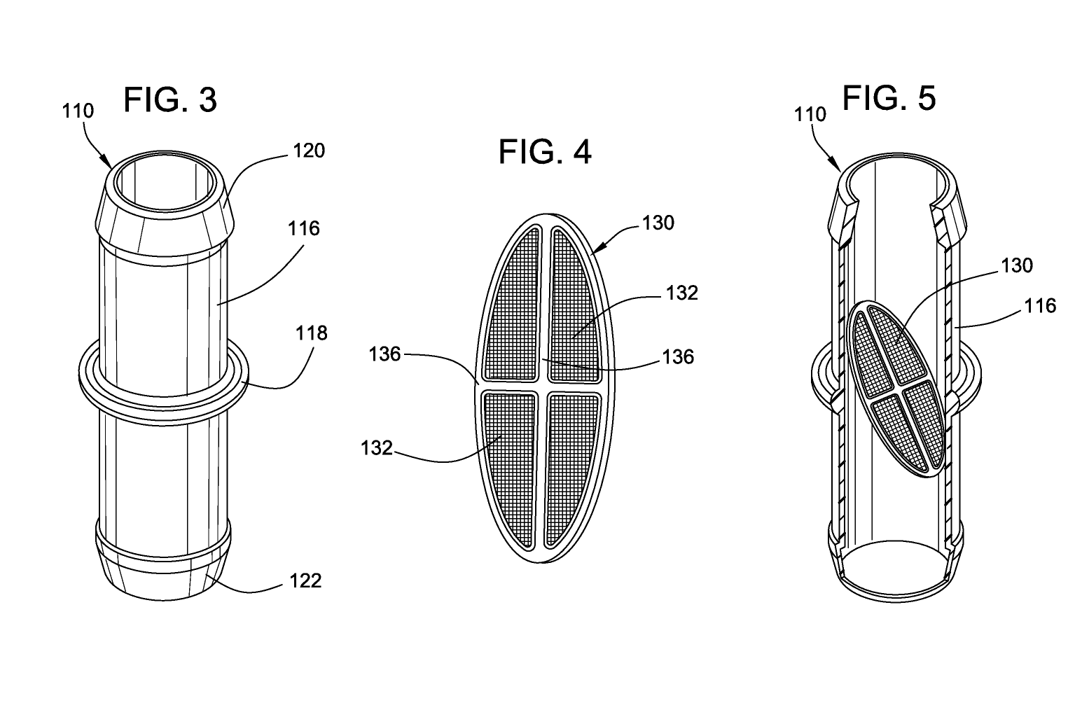

A coupling filter illustrative of the principles of the disclosure is seen in FIGS. 3 to 5. Coupling filter 110 is a component of a fluid system inserted between adjacent ends of hollow tubular fluid conduits such a flexible hose or tubing. Illustrated in FIGS. 3 to 5, coupling filter 110 includes a tubular body 116 defining a flow passage with filter element 130 integrated into the body 116 and obliquely disposed within the fluid flow passage.

Hollow cylindrical tubular body 116 includes a centrally disposed radial stop 118 to limit insertion within an associated tube or hose. It includes barbs 120 and 122 at opposite end of body 116 that coact with the interior surface of the tube or hose for a fluid tight relationship. The coupling filter body 116 is a molded plastic component made from a suitable polymeric material such as acetel.

Alternatively, the cylindrical tubular body 116 need not include the exterior radial stop 118 or barbs 120 or 122 at its opposite ends. In this form, the cylindrical body 116 may conveniently be inserted into a flow passage defined by a tubular member to provide the filtering function.

Filter element 130, seen in FIG. 3 includes a skeletal frame 132 that supports a screen mesh filter media 136. Filter element 130 is oblong or oval shape having a minor axis dimensions about the same size as the diameter of the internal passageway of the hollow cylindrical tubular body 116. The major axis of filter element 136 determines the overall length of the filter element and is based on the open area requirement for fluid flow through the filter media. As best seen in FIG. 5, the filter element 130 is supported internally of the hollow tubular body 116, with the outer perimeter of skeletal frame 132 in fluid tight relation to the internal surface of the wall of the body 116. Optionally, the filter element 130 including skeletal frame 132 and filter media 136 are a preformed component insert molded into the tubular body 116. That is, the filter element 130 comprising frame 132 and filter media 136 is molded first and then overmolded into the flow passage of body 116 during molding of the body.

Significantly the filter element 130 is disposed diagonally, that is, slanted or sloped relative to the path of fluid flow. Thus the filter screen 130 is neither parallel to the interior of the tubular wall of the coupling body 116 nor perpendicular to it. However, flow through the interior of the tubular body is generally parallel to the longitudinal extent of the body 116. Also, as best seen in FIG. 5, the coupling filter is symmetrical. That is, either end may comprise the inlet, or the outlet without affect ting function or performance.

The mesh size or open mesh area of filter media 136 may be chosen based on the expected particle size of the contaminants being filtered. The total open area is then established by the length of the major axis of the frame 132 along the flow axis of the tubular body 116.

As can be appreciated, coupling filter 110 is readily installed into a fluid system by insertion between adjacent spaced ends of aligned fluid conduits. The tubular body of the coupling filter 130 is received within the inner tubular surface of the flow conduits. The radial stop 118 establishes the insertion limit into each conduit. The barbs 120 and 122 radially expand the tubular flow conduits, usually flexible hose or tubing, to provide a fluid tight relationship. All fluid flow through the tubes 112 and 114 passes through, and is filtered by, the filter mesh media 136, regardless of direction of flow.

With the coupling filter of the present disclosure, the body axial length of coupling filter 110 body 116 has the same axial extent as a coupling to connect two adjacent flow conduits. A filter coupling as herein disclosed can readily be incorporated into an existing fluid system. It is essentially a “drop-in” filter replacement with enhanced ability for filtration and easy connection. It is easily adapted to any filter coupling application within a fluid conduit comprising hollow tubular construction.

The oblique disposition of the filter element 130 provides ample open area for the mesh filter media to avoid presentment of a restrictive orifice within the system. The open flow area through the screen mesh may exceed the cross-sectional area of the associated fluid conduit. It is contemplated that the open flow area of the screen mesh filter media could be three or more times the cross sectional area of the associated flow conduit.

The life expectancy of any filter is adversely affected by the accumulation of the particulate matter that is being filtered from the system. With the angled or oblique position of the filter media fluid flow “naturally” forces the accumulated particulate into smallest area of the filter by continually “washing” the larger portion free thus extending the life expectancy of the filter and in consequence, the life expectancy of the system in which the filter is used.

Because the coupling filter 110 illustrated is symmetrical between its ends. Therefore its position relative to fluid flow is reversible, and does not require orientation during assembly. This property simplifies assembly, reduces inventory and eliminated potential errors in replacement or repair activity. The oblique disposition of the filter element 130 provides for flexibility in sizing the filter element 130 relative to the length of the coupling body 116 to ensure adequate filtration capacity for a given application. The increase in area of the filter media can also ultimately mean that smaller and consequently less expensive components can be utilized to fulfill system requirements.

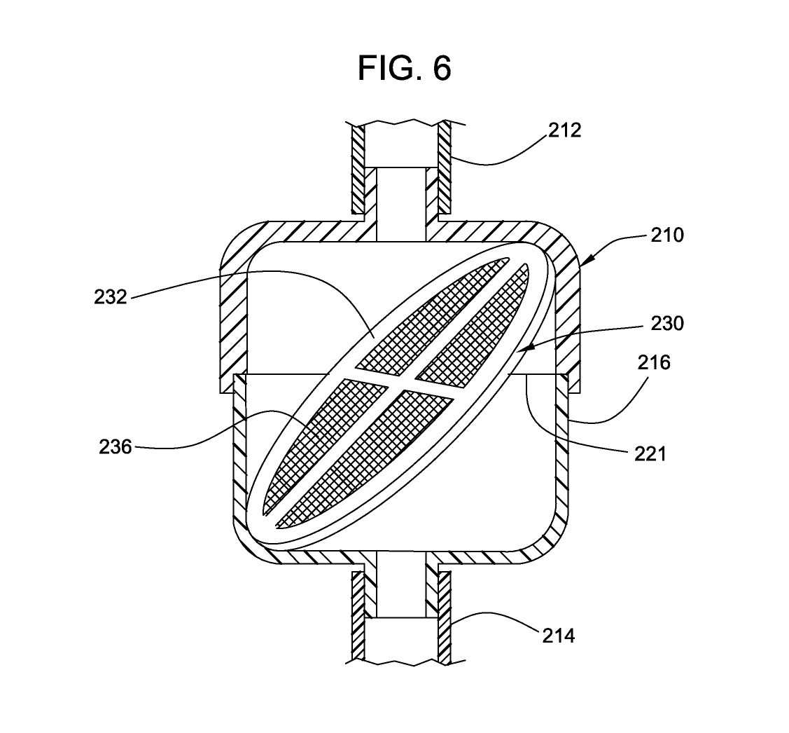

Though the advantages derived are particularly suitable for filter coupling components as described above, the benefits of the oblique disposition of a filter media is considered widely applicable to innumerable fluid filtration applications. For example, in FIG. 6, a filter housing or canister is illustrated which includes an obliquely disposed filter element. Such a canister may be suitable for oil filtration in power steering or engine applications.

FIG. 6 shows a plastic molded filter canister or housing 210 connected between fluid conduits 212 and 214. Canister 210 defines a hollow cylindrical body 216 having an inlet port 217 and an outlet port 219. It comprises canister halves joined along a seam 221 sealed by friction welding or sonic welding or similar process.

A filter element 230 is positioned obliquely of body 216. It includes a plastic molded oval skeletal frame 232 that supports a mesh filter media 236. Oval frame 232 is secured in fluid tight relation to the inside of canister 210. It has a minor axis dimension about the same as the internal diameter of the canister body 216. The major axis dimension is determined by the desired open flow area through filter media 236.

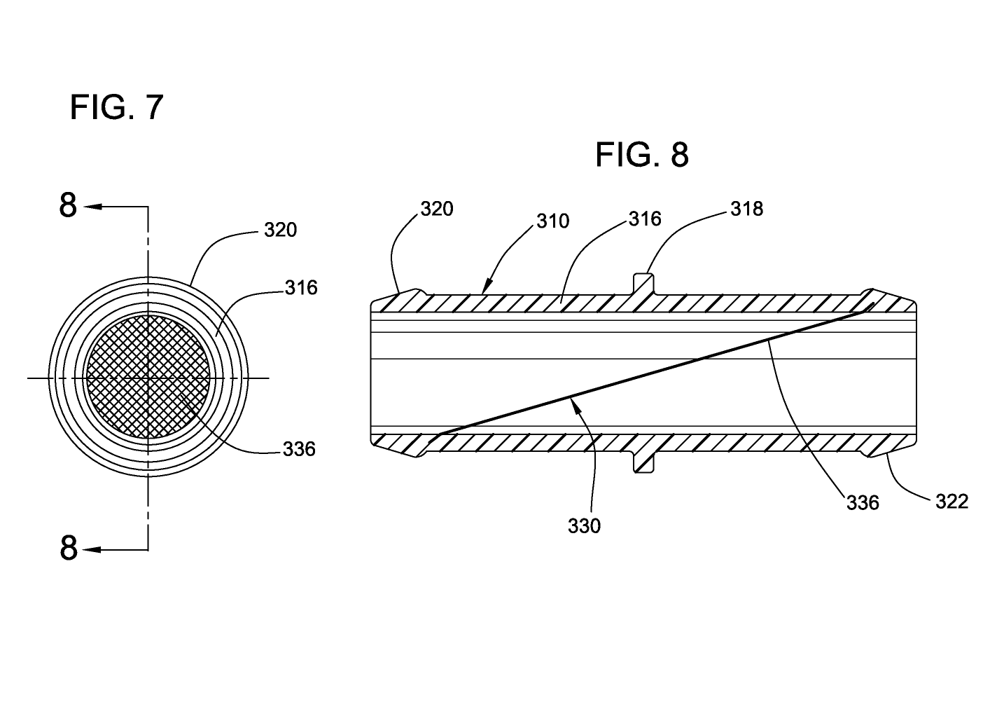

Illustrated in FIGS. 7 and 8 is a coupling filter 310 which, as in the earlier embodiment, includes a hollow tubular body 316 with filter element 330 integrated into the body 316 and obliquely disposed within the fluid flow path. The coupling body 316 is molded of plastic made from a suitable polymeric material such as acetel. Filter element 330 comprises a filter media in the form of a stainless steel mesh screen 336 which is insert molded in the hollow tubular coupling body 316.

Hollow tubular body 316 includes a centrally disposed radial stop 318 to limit insertion within an associated tube or hose. It includes barbs 320 and 322 at opposite ends that coact with the interior surface of the tube or hose for a fluid tight relationship.

Filter element 330 comprises filter media 336 in the form of stainless steel mesh screen. It is oblong or oval shape having a minor axis dimensions about the same size as the diameter of the internal passageway of the hollow cylindrical tubular body 316. The major axis of filter element 336 determines the overall length of the filter element and is based on the open area requirement for fluid flow through the filter media.

As best seen in FIG. 8, the filter element 330 in the form of stainless steel mesh screen 336 is supported internally of the hollow tubular body 316, with the outer perimeter of stainless steel mesh screen 336 secured in fluid tight relation within the tubular wall of the body 316.

In this illustrated embodiment, the stainless steel mesh filter media 336 is sized to be overmolded into the tubular body 316 of coupling filter 310. Filter element 330 is thus in fluid tight relation to the interior of the tubular body 316 and all fluid flow through the passageway defined by tubular body 316 must pass through stainless steel mesh screen 336. As in the other disclosed embodiments, the filter element 330 is disposed diagonally, that is, slanted or sloped relative to the path of fluid flow.

The mesh size or open mesh area of stainless steel screen filter media 336 may be chosen based on the expected particle size of the contaminants being filtered. The total open area is then established by the length of the major axis along the flow axis of the tubular body 316.

As can be appreciated, coupling filter 310 is readily installed into a fluid system by insertion between adjacent spaced ends of aligned fluid conduits. The tubular body of the coupling filter 330 is received within the inner tubular surface of the flow conduits. The radial stop 318 establishes the insertion limit into each conduit. The barbs 320 and 322 expand the tubular flow conduits, usually flexible hose or tubing, to provide a fluid tight relationship. All fluid flow passes through, and is filtered by, the stainless steel mesh screen 336.

Again with the coupling filter of the embodiment of FIGS. 7 and 8 of the present disclosure, the body axial length of body 316 of coupling filter 310 is no longer than a coupling to connect two adjacent flow conduits. A filter coupling as herein disclosed can readily be incorporated into an existing fluid system.

The oblique disposition of the stainless steel mesh screen 336 provides ample open area to avoid presentment of a restrictive orifice within the system. The open flow area through the screen mesh may exceed the cross-sectional area of the associated fluid conduit. It is contemplated that the open flow area of the screen mesh could be three or more times the cross sectional area of the associated flow conduit.

The coupling filter 310 illustrated is symmetrical relative to the fluid system and its position relative to the fluid flow reversible. It therefore does not require orientation during assembly. This simplifies assembly, reduces inventory and eliminated potential errors in replacement or repair activity. The oblique disposition of the filter element 330 provides for flexibility in sizing the filter element 330 relative to the length of the coupling body 316 to ensure adequate filtration capacity for a given application.

Though the advantages derived are particularly suitable for filter coupling components as described above, the benefits of the oblique disposition of a filter media is considered widely applicable to innumerable fluid filtration applications.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain he best modes known for practicing the invention and will enable others skilled in the art to utilize the invention. The claims are to be construed to include alternative embodiments to the extent permitted by the prior art.

1. A filter assembly comprising:
a hollow body defining a flow passage between its ends;
a porous filter media extending across said flow path disposed obliquely in said hollow body between its ends.

2. A filter assembly as claimed in claim 1 wherein said porous filter media has an oblong shape.

3. A filter assembly as claimed in claim 2 wherein said filter media has a dimension along said flow passage that exceeds the dimension across said flow passage.

4. A filter assembly as claimed in claim 3, wherein said assembly is symmetrical between its ends.

5. A filter assembly as claimed in claim 3 wherein said body is tubular and said filter media has a minor axis the same as the diameter of said flow passage of said tubular body and a major axis having a length that exceeds the diameter of said flow passage of said tubular body.

6. A filter assembly as claimed in claim 4, wherein said hollow body includes separate molded elements connected together to form a flow passage.

7. A filter assembly as claimed in claim 6 wherein said separate molded elements are connected together by friction welding or spin welding.

8. A coupling filter for a fluid system comprising:
a hollow tubular body defining
a flow path between its ends;
a porous filter media disposed between said ends of said body extending obliquely across said fluid flow path.

9. A coupling filter as claimed in claim 5 wherein said body defines a coupling having an exterior barb at each end.

10. A coupling filter as claimed in claim 8 wherein said body defines an exterior abutment spaced between said barbs at said ends.

11. A coupling filter as claimed in claim 8 wherein said filter media comprises a molded plastic element.

12. A coupling filter as claimed in claim 11 wherein said filter media is overmolded into said wall of said plastic tubular member.

13. A coupling filter as claimed in claim 8 wherein said filter media comprises a stainless steel mesh.

14. A coupling filter as claimed in claim 13 wherein said filter media is overmolded into said wall of said plastic tubular member.

15. A coupling filter as claimed in claim 14 wherein said filter media has a dimension along said flow passage that exceeds the dimension across said flow passage.

16. A coupling filter as claimed in claim 15 wherein said filter media has a minor axis the same as the diameter of said flow passage of said tubular body and a major axis having a length that exceeds the diameter of said flow passage of said tubular body.

17. A coupling filter as claimed in claim 8 wherein said filter coupling is symmetrical between its ends.

18. A coupling filter as claimed in claim 14 wherein said filter coupling is symmetrical between its ends.

19. A method of making a coupling filter having a hollow tubular body defining a flow passage between its ends and a porous filter media disposed in the flow passage between said overmolding said filter media into said body obliquely across said flow passage.

20. A method of making a coupling filter as claimed in claim 19 further comprising providing a stainless steel mesh filter media, overmolding said stainless steel mesh filter media into said hollow tubular body.
